(19) United States
(12) Patent Application Publication
(10) Pub. No.: US 2002/0060124 A1
(43) Pub. Date: May 23, 2002

(54) GAMING MACHINE CABINET AND RELATED METHODS

(76) Inventor: WILLIAM W. THOMPSON, FOUNTAIN VALLEY, CA (US)

Correspondence Address: J MARK HOLLAND & ASSOCIATES, 3 CIVIC PLAZA SUITE 210, NEWPORT BEACH, CA, 92660

(21) Appl. No.: 09/305,231

(22) Filed: May 4, 1999

(51) Int. Cl. G07F 9/06

(52) U.S. Cl. 194/350

(57) ABSTRACT

A base structure is disclosed for the installation and support of one or more gaming machines (sometimes referred to as, but not limited to, slot machines). The base includes mounting or attachment means for attaching the gaming machine or machines, including a removable interface element between the remainder of the base and the gaming machine. A uniform attachment structure between the interface element and the remainder of the base enables ready customization of those elements to accommodate differing gaming machines and their specific attachment structures (as well as wiring and coin drop locations), permitting the ready replacement or moving of gaming machines without the need to move or change the entire base structure. The base structure can also house electrical wiring, provide a secure enclosure for money overflow (drop), and provide storage for support supplies such as bill acceptor boxes and refill coin. Replaceable aesthetic panels are disclosed to further expand and lengthen the life of the base units. Preferred methods are also disclosed.

### BACKGROUND OF THE INVENTION

Base cabinets for gaming machines, such as slot machines, have probably existed for as long as there have been gaming machines. Among other things, they present the machine at a convenient height for patrons.

As stated in Berman, U.S. Pat. No. 5,678,679, the slot machine, a gaming machine that typically utilizes base cabinets, is commonly mounted on a knee high counter top in a manner to maximize aisle space and minimize space taken up by the slot machine. Efficient space utilization is typically achieved by placing rows of slot machines in a back to back configuration. The side clearance between machines is generally sufficiently wide to accommodate a player's coin bucket and slot arm pull.

Because the cabinets can also serve aesthetic and other purposes, and because they sometimes become damaged (as discussed below), the cabinets typically are not integral with the gaming machine but are separate units. Among the advantages of that approach is the flexibility afforded to casinos and other machine users to change the decor of the base cabinets and to otherwise be able to use the relatively much more expensive gaming machine on any of a variety of relatively much less expensive cabinet bases.

For security and other reasons, current gaming machines are typically bolted to the top of the cabinet. Among other things, in a casino slot machine, wagered coins are not all held in the slot machine, awaiting a player's winning pull. Instead, when the machine's internal capacity is full, the excess or overflow is discharged, or “dropped”, from a coin drop area located in the underside of the slot machine. These coins represent, or are at least related to, the casino's or house's gross income. The “drop” is separate from that portion of the coins that are held by the machine and periodically released by the machine to the “winning” player, typically via the lower front tray of the slot machine. Coins to supply players' winnings can be periodically recharged into the machine by casino personnel.

As indicated above, slot machines are traditionally installed on cabinet type bases that provide some sort of mounting platform. Typically, and for reasons including those explained herein, multiple bases are separately manufactured and subsequently assembled at the installation site. As indicated above, each slot base cabinet unit is aesthetically customized for a particular customer's location and its current or intended decor and style. Perhaps more importantly, however, because there is no standardization in the design of many features of the gaming machines, the bases must be customized to accommodate each particular type of machine, its attachment structure, its drop location, and other factors.

As indicated above, to provide storage and security for the machine's overflow of coins (the “drop”), the base cabinet and the bottom of the slot machine typically are not only securely connected to each other but the cabinet top also includes a hole through which the “drop” falls from the machine into the cabinet's interior. Other holes in the cabinet tops are similarly customized in size, shape, and/or location on that top to pass electrical wires from the machine to the base and floor.

In addition, such cabinets also typically provide a secure storage area inside the cabinet. Among other things, this provides a secure enclosure for the money overflow (drop), and provides storage for support supplies such as bill acceptor boxes and refill coins.

In addition, in casino environments, gaming machines are sometime moved or replaced (e.g., “hot” machines are moved to optimal locations on the casino floor to attract customers, etc.), or the cabinet bases sometimes become damaged by cigarette bums, scratches or the like. Also, in the competitive casino business, it can be important to regularly update the aesthetics of the gaming machine areas, by changing decor (such as color schemes), etc. These aesthetic updates can involve or require the refinishing or outright replacement of the afore-mentioned cabinet bases, typically at a not insubstantial cost.

As indicated above, there is no standard pattern for the attachment structures (typically supporting bolts or bolt holes) on different gaming machines (or for the other drop holes, electrical holes, etc. that must be included in the cabinet top). Due to the number, size, and location of the holes typically required to accommodate any particular machine, the cabinets typically are custom made to fit a single type of machine. Accordingly, the cabinets are not widely interchangeable with each other, and the costs for maintenance, replacement, inventory, and repair can be significant.

An example of a prior art cabinet is shown in FIG. 1, which shows a cabinet base prior to it being customized with a hole pattern in its top and access doors. The holes must be cut to fit the pattern of the particular gaming machine. Although Berman assertedly is directed to a “universal” slot machine mounting unit, Berman apparently shows only a one-piece base that cannot be updated for new slot machine models in the future. Berman's universal mounting unit appears to use a set pattern of drop and electrical penetrations which are oversized, to accommodate some range of drop and electrical hook-ups for different machines, but certainly not for all gaming machines. Berman does not, however, include any attachment fastener holes for attaching any specific gaming machine to the base. Accordingly, Berman's base may apparently support a number of models of slot machines, but still requires that a unique pattern of fastener holes be machined into the base (to attach the selected machine). As discussed elsewhere herein, there is no way that Berman can provide in a single one of its cabinets fastener patterns for the entire range of gaming machines that exist or may come to exist. Thus, Berman's approach still retains a substantial element of inflexibility, in that future or other models of gaming machines may require a different pattern of holes through which to not only to pass coins and electrical wires, but especially must be “customized” for the fastener pattern for a specific, selected machine. Generally, once the fastener pattern is machined, changing to a machine with a different pattern requires that Berman's entire cabinet be replaced (which is one of the conventional problems discussed above).

Other problems exist with current base cabinet systems. In the casino business, often the choice of the specific gaming machines and their location within the casino is not made until relatively late in the development stage. This applies not only for remodeling or renovating, but perhaps especially for newly-built casinos. Because of the required customization discussed herein, the cabinets for the machines cannot be selected, manufactured, or installed until the businessperson selects the specific gaming machines, since the necessary customization can only proceed after the particular make and model of gaming machine is chosen. Only when the exact number and make and model of the gaming machines is determined can the customization of the cabinets be completed. This interdependence reduces efficiency in manufacturing, storage, and otherwise (consequently increasing costs) and can cause delays.

Because casinos typically have hundreds or even thousands of gaming machines and associated customized bases, the problems discussed above (including the logistics, costs, and other considerations affecting those base units) can be substantial.

### OBJECTS AND ADVANTAGES OF THE INVENTION

Accordingly, it is an object of the present invention to provide an improved method of installing, changing, or removing gaming machines that avoids or reduces the need to replace, rebuild or repair the base cabinet, or at least a substantial portion thereof.

It is another object to provide a readily selectable, replaceable, changeable, durable exterior surface for the exposed surfaces of a base cabinet. Preferably, these are in the form of removable decorative panels that can removably attach to the base cabinet.

Still another object to a provide a supporting structure having at least one face completely or partially open and having means for attaching a removable interface plate to the face that is partially open, whereby the interface plate is configured to attach to one or more models of selected gaming machines.

Yet another object of the invention is to provide an improved system for selecting, installing, positioning, and maintaining gaming machines in a casino environment, including providing a plurality of gaming machine support structures and a plurality of replaceable decorative panels attachable to the support structures.

A further object of the invention is to provide a support structure for a gaming machine, including a supporting surface having an opening therethrough, an interface element adapted to be positioned adjacent said opening, the interface element having one or more attachment structures thereon for attachment to a selected gaming machine, and means for removably attaching the interface element to the support structure so that the element is adjacent the opening

It is still another object to provide a method of installing a plurality of support structures for gaming machines, including the steps of: providing a plurality of support structures, each having an opening therethrough; arranging the support structures in a gaming room; providing a plurality of interface elements uniformly adapted to be positioned adjacent any of the openings, each of the interface elements having one or more attachment structures thereon for attachment to a selected gaming machine, and means for removably attaching the interface element to the support structure so that the element is adjacent the opening; and attaching the interface plates adjacent respective of the openings. Additional steps can include attaching decorative panels to the support structures.

Yet another object of the invention is to provide a method of removing and replacing gaming machines in a casino environment, including the steps of: providing a plurality of uniform support structures for the gaming machines, each support structure having one or more openings positioned toward a corresponding one of the machines; providing a plurality of interface elements adapted to be positioned adjacent the openings, the interface elements having one or more attachment structures thereon for attachment to a selected gaming machine, and means for removably attaching the interface element to any of the support structures so that the element is adjacent the corresponding opening; removing the gaming machine from the support structure; if the new gaming machine includes features not adaptable to the existing interface plate, removing the interface plate and attaching an interface plate adapted for the new gaming machine, and attaching said new gaming machine to said new interface plate.

Other objects and advantages of the invention will be apparent from the following specification and the accompanying drawings, which are for the purpose of illustration only.

### BRIEF DESCRIPTION OF THE DRAWINGS

FIG. 1 is an isometric view of a prior art base cabinet for a gaming machine;

FIG. 2 is a partially exploded isometric view of a preferred embodiment of the present invention, showing the interface plates separated from the rest of the support structure;

FIG. 3 is similar to FIG. 2, but illustrates the interface plates assembled with the rest of the cabinet;

FIG. 4 is an exploded isometric view of a preferred embodiment of the invention, including its decorative panels;

FIG. 5 is similar to FIG. 3, but illustrates the attachment of decorative exterior panels;

FIG. 6 is cross-sectional view along reference line 6-6 of FIG. 5;

FIG. 7 is a top view of three units of a preferred embodiment placed side-by-side;

FIG. 8 is a top view of the preferred embodiment showing a superposition of some of the various possible hole patterns for different gaming machines; and

FIG. 9 is similar to FIG. 4, but is an exploded view of one of the many alternative embodiments of the invention.

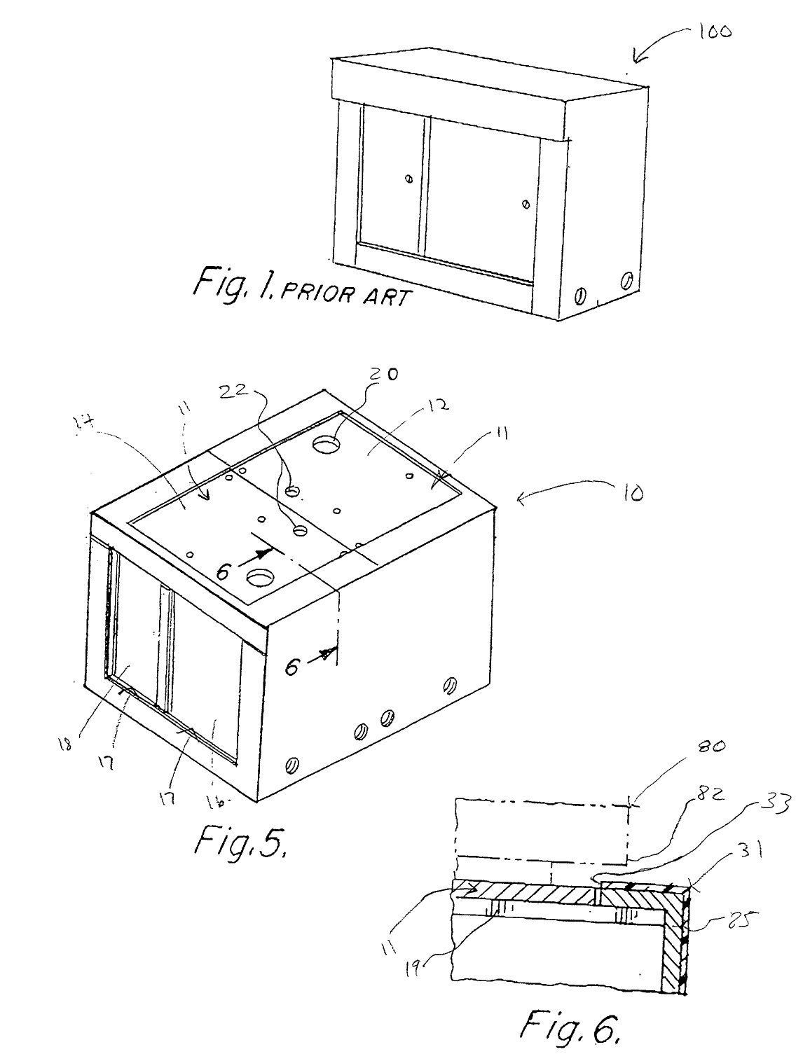

### DESCRIPTION OF PREFERRED EMBODIMENT

Referring now to the drawings, and particularly FIG. 5, 1 show a preferred embodiment of a gaming machine cabinet or base or stand 10, fabricated and constructed in accordance with the teachings of the invention. The embodiment of FIG. 5 is shown in duplex form (meaning the cabinet can support two gaming machines) with decorative panels 31 attached thereto (a further description of the panels is set forth below). The cabinet is preferably fabricated of sheet metal, but may be fabricated from a wide range of suitable materials, including wood or other materials, as would be apparent to a person of ordinary skill in the art.

The preferred cabinet or base or stand I O includes one side that is at least partially covered by two removably attachable interface plates I 11. Persons of ordinary skill in the art will understand that each interface plate is preferably configured to support a single gaming machine, but that alternative embodiments (not shown) include providing a single interface plate sized and shaped to support two or more gaming machines (such as would result from forming or affixing the two plates 11 in FIG. 5 to each other).

In addition, persons of ordinary skill in the art will recognize that the duplex embodiment of FIG. 5 is only one of many possible embodiments of overall cabinet configuration (even if single-machine interface plates are used). Alternative cabinet structures include, but are not limited to, cabinets that are designed to support single, four, six or more gaming machines by means of one integrated cabinet support structure, and cabinets that have one or more sides (including the side facing the gaming machine) completely open rather than partially open.

Rather than building ever-larger integral cabinets to accommodate larger numbers of machines, however, the preferred embodiment of FIG. 5 readily lends itself to use in conventional casino alignments. An example of such a possible arrangement of the cabinets involves placing the duplex embodiment side-by-side with two or more other duplex cabinets, in the manner illustrated in FIG. 7. That FIG. 7 shows a top view of three gaming machine cabinets 10 placed adjacent to one another to form a more complex arrangement 64.

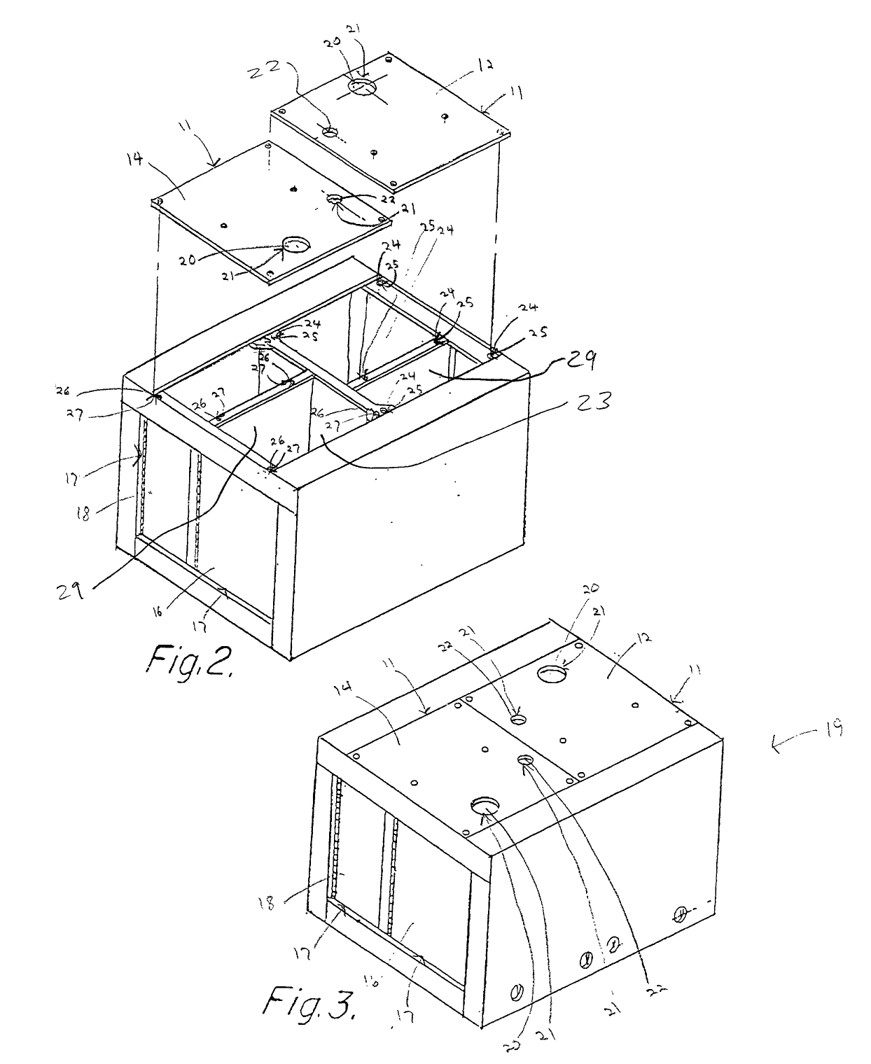

FIGS. 2 and 3 illustrate a preferred underlying structural assembly of the supporting structure 19 (which is the preferred “skeleton” of the gaming machine stand 10), without decorative or aesthetic covering elements such as panels 31 (described further below). The preferred embodiment of the cabinet 10 is generally cube-like, although persons of ordinary skill in the art will understand that the invention may be beneficially used in a wide variety of shapes and configurations (not shown, but including, without limitation, cabinets or supporting structures having plan views in the shape of pentagons, hexagons, etc.).

The preferred stand 10 preferably constitutes an encloseable, secure container, for purposes such as discussed herein. Persons of ordinary skill in the art will understand, however, that many beneficial aspects of the invention can be practiced without the stand 10 having any “enclosed” area under the gaming machine. By way of example, if machines are used that do not utilize coins or tokens, no “drop” is necessary and the associated need for security under the machine is lessened or eliminated. As technology progresses and “smart cards” or other technologies may make tokens obsolete on some gaming machines, the aforementioned need for security may likewise become less. For these and other applications, including applications that may not involve gaming machines, other aspects of the invention (such as the readily changeable aesthetic elements or the readily moveable machines and interface plates) may still provide substantial advantages over prior art approaches.

For applications in which the stand 10 does provide an enclosure below the gaming machine, the support 10 preferably includes one or more access points 17 to permit selective, controlled access to the interior of the stand 10. In the preferred embodiment of FIGS. 2 and 3, those access points 17 are closable by doors 16 and 18. Many alternative embodiments of the access points 17 will be apparent to persons of ordinary skill in the art. As indicated herein, the access points 17 and their associated doors 16 and 18 are useful to permit selective and controlled access to money or supplies (such as bill acceptor boxes ) that may be located and/or stored within the stand 10.

In the preferred embodiment of FIG. 2, interior walls 23 and 29 can be provided (preferably in the form of sheet metal or other suitably strong material) to both divide the interior of the cabinet 10 into separate compartments and support mounting means 25 and 27 as discussed herein. Separate compartments can provide added flexibility of use, in that certain casino personnel can have access (via keys, etc.) to the “drop” compartment, and other personnel can have access to the non-drop, storage compartment. Persons of ordinary skill in the art will understand, however, that such interior walls 23 and 29 do not need to be used at all to practice certain aspects of the invention, and that other patterns and constructions of such walls may be utilized, but that such walls can strengthen the structure 10 and improve the support of the gaming machine and the interface plates 11 discussed herein.

In FIG. 2 the preferred removable interface plates 11 with customized openings or hole patterns 21 thereon are shown here in the preferred embodiment as rectangular plates 12 and 14. Preferably, the plates 11 are provided with hole patterns including “drop” holes 20 (for coin overflow, as discussed above) and electrical power cable openings 22, which respectively permit passage of coins and electrical wire from the gaming machine 80 into the cabinet 10.

The plates 11 are preferably made of sheet metal, but may be constructed of any suitably strong material, including wood, plastic, etc. Persons of ordinary skill in the art will understand that the size and shape of plates 11 (including their size and shape relative to the rest of the cabinet 10) can range widely, including many shapes and sizes other than the preferred generally rectangular shape that is slightly smaller than the footprint of the gaming machine illustrated in the drawings. By way of example and not by way of limitation, the plates 11 could alternatively cover the entire top of the cabinet 10, or could consist of a “web” of metal that basically extended from each of the necessary “standard” and “custom” holes (as discussed herein) and was otherwise open. In the latter embodiment, the aforementioned desirable security inside the cabinet 10 can be achieved if the margins of the opening in which the interface plate I 1 is placed remain slightly smaller than the exterior lower dimensions of the game machine (in which case the game machine itself would preclude unauthorized access through the cabinet top to the interior of the cabinet 10 because, as illustrated in FIG. 6, the openings between the machine and the cabinet would be too small to permit ready access from the exterior to the interior).

The hole patterns 21 preferably also include a “standard” or uniform set of holes as part of attachment means 25 and 27 to facilitate attachment of the interface plates 11 to the rest of the cabinet. Because these are provided in a uniform position, other interface plates 11 can be provided with that same standard attachment means pattern and so be readily and interchangeably mounted onto the cabinet 10 without the need to remove or otherwise manipulate the entire cabinet. Persons of ordinary skill in the art will understand that although the preferred embodiment shows bolt locations 24 and 26 for attaching the interface plates 12 and 14 to the body of the cabinet, attachment means 25 and 27 may consist of a wide variety of other suitable connection members, including but not limited to over-center or other latches, slots and grooves. Moreover, the location of those “standard” attachment means on the cabinet 10 is not critical for many aspects of the invention, although the benefit of the interchangeable interface plates 11 requires that the pattern be uniform for all such plates 11.

As indicated above, custom holes 20 and 22 accommodate the coins that are dropped and electrical attachments from the selected gaming machine. The cabinet can receive and store overflow coins from the gaming machine, which can then be removed from the access door 16. The electrical connection through hole 22 preferably provides power and other electrical interfaces to the gaming machine. Persons of ordinary skill in the art will understand that, although two doors are illustrated in the drawings, the number of doors or access panels 17, the number, size and shape of the interior compartments accessible therethrough, and the specific compartment within which the drop and the electrical connections are located, can be an of a wide range. Among other things, cabinets in New Jersey casinos conventionally include three such doors 17.

The hole patterns 21 on interface plates 11 also preferably include additional customized holes or other attachment means designed to operatively attach to the bottom of a selected gaming machine. As indicated above, the pattern of attachment structures (such as bolts, threaded holes, etc.) on the bottom of a gaming machine varies with each make and model of gaming machine. Persons of ordinary skill in the art will understand that those further “custom” holes are not shown in FIGS. 2-7 or 9, but that examples of same are illustrated in FIG. 8. In the preferred embodiment, the hole patterns 21 of each interface plate 11 contain just one set of additional custom hole patterns to support one make and model of gaming machine. Persons of ordinary skill in the art will understand that many other embodiments and approaches are possible within the teachings of the invention. FIG. 8, for example, shows a duplex gaming machine cabinet or base or stand 62 with interface plates 11 with particular embodiments 58 and 60 of an interface plate in which six separate patterns of holes 21 are illustrated (in addition to the “standard” attachment means 25 and 27).

Although actually machining all six of these patterns 21 into the plates 11 would result in a “Swiss-cheese” plate 11 having questionable structural integrity and being of questionable use for at least certain of the machines (e.g., the necessary hole 41 for attaching one of the six machines would be “removed” by machining in the larger drop hole 43), at least some of the patterns 21 (or other combinations of useful patterns) could be provided on a single plate 11 without rendering any of the “multiple” patterns 21 useless. Because far more than those six patterns exist in current gaming machines, however, there is no way that any single cabinet top or plate 11 can be configured to receive all possible gaming machines. In that way, at least, FIG. 8 at least partially illustrates some of the problems discussed above that have led to the entire prior art cabinets typically being disposed of when their gaming machine is changed.

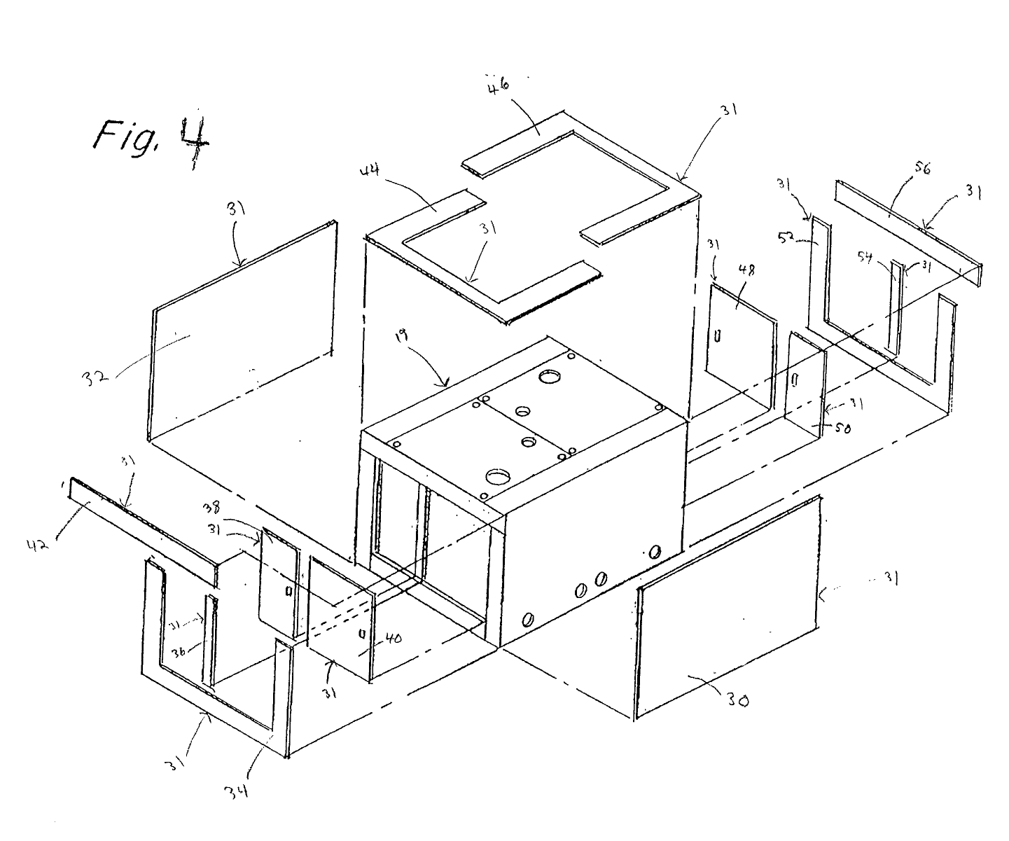

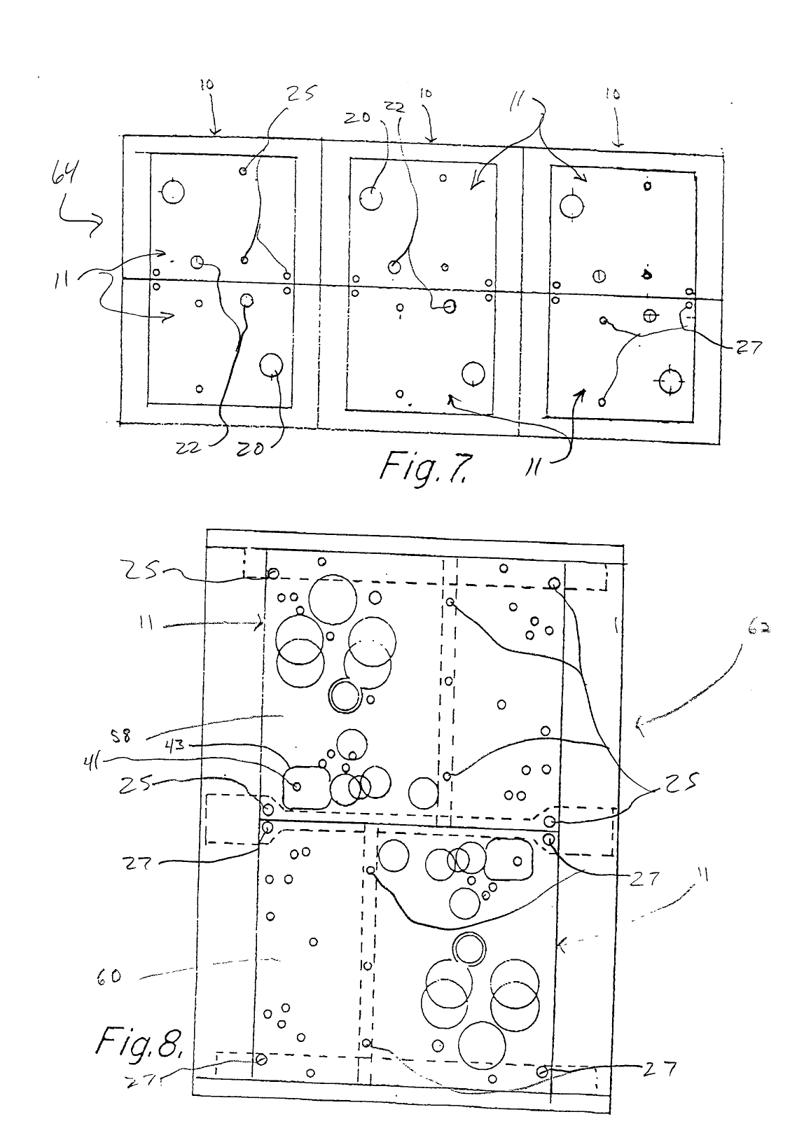

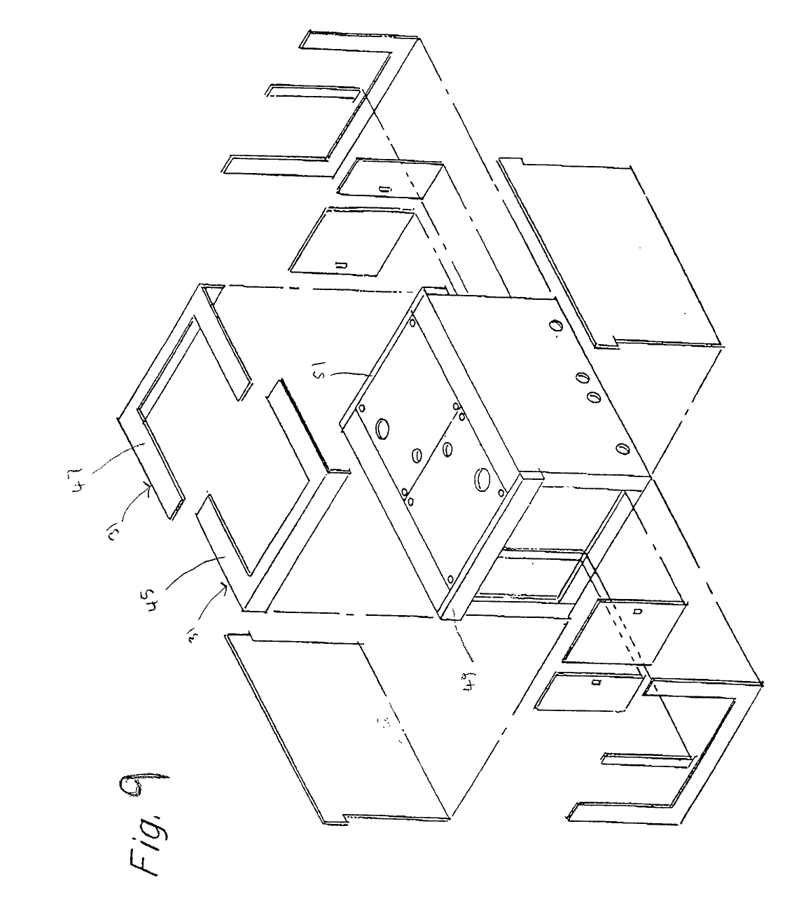

The preferred embodiment also includes removable decorative or aesthetic elements or panels 31 on the exterior of the cabinet. FIGS. 4 and 9 show some of the many embodiments of this aspect of the invention. FIG. 4 shows an exploded isometric view of decorative fascia panels 31 and their respective areas of placement on the underlying structure 19 of the cabinet 10. In the preferred embodiment, panels 30, 32, 34, 36, 38, 40, 42, 44, 46, 48, 50, 52, 54, and 56 are fastened or attached to the cabinet 19 by any suitable methods, preferably in a removable manner to facilitate changing the panels in case one of them is damaged, the casino's interior decor is updated, etc. Among the many methods of attaching the panels are using Velcro®, double-sided adhesive tape, screws, slots, etc. In the preferred embodiment, the attachment of the panels 31 results in no exposed fasteners on the exterior of the cabinet 10. The decorative panels 31 are preferably made of damage-resistant material such as vinyl/metal laminate that is manufactured under the trade name Vinylam.

In the alternative embodiment of FIG. 9, decorative panels 31 include “combination” panel members 45 and 47 that illustrate some of the various alternative configuration in which the panels 31 may be embodied. Persons of ordinary skill in the art will also understand that FIG. 9 also illustrates some of the wide variety of different underlying skeleton supports 19 useful as part of the invention, including extended, thicker structures 49 and 51. Many other possible configurations of decorative panels 31 and underlying support structures 19 are possible, as will be readily understood by persons of ordinary skill in the art.

Further aspects of the preferred decorative panels 31 can be appreciated from FIG. 6, in which the gaming machine 80 is indicated in phantom and can be any of a variety of gaming machines, such as slot machines, video poker, etc. The machine 80 and the other components of the invention are preferably sized, shaped, configured, and positioned with respect to each other so that the edge of the machine 82 extends over the edge 33 of the decorative panel 31 such that the neither the interface plate 11 nor the underlying cabinet structure 19 is visible from the exterior when the gaming machine 80 is assembled with the cabinet. The provides a desired aesthetic effect, in which players and passers-by view whatever decorative panel is selected, rather than any other aesthetic elements of the cabinet 10.

The invention also includes a number of related useful methods. For example, persons of ordinary skill in the art will understand that, among many advantages of the invention over the prior art, it permits a casino or other gaming machine operator to readily reorganize, move, or change out the gaming machines without moving the cabinet bases 10 or an array of bases such as illustrated in FIG. 7.

Moreover, the bases or stands 10 can be selected and installed independently and in advance of the decision as to which particular gaming machine is to be mounted on which particular base 10. Instead, the bases can be installed and arranged, following which the gaming machine selection can be made. Thereafter, the interface plates 11 can be customized for the selected machines, assembled to the machines, and attached to the appropriate, previously installed bases.

Another improved method of the invention relates to installing a plurality of support structures for gaming machines, and includes (in no specific order) the steps of: providing a plurality of base cabinets 10 of the character described above; arranging them in a gaming room (in any desired pattern, including the pattern shown in FIG. 7); providing a plurality of interface elements 11 adapted to be positioned adjacent the openings, the interface elements 11 having one or more customized attachment structures thereon for attachment to a selected gaming machine, the interface elements 11 also having uniform or “standard” means for removably attaching the interface element to the cabinet adjacent to the opening, so that each interface element 11 is interchangeable with the others; attaching the interface elements adjacent respective of the openings so that desired gaming machines can be positioned at specific locations within the gaming room; and attaching decorative panels 31 to the cabinets.

Even a “single” gaming machine installation (such as in a small hotel lobby) can benefit from aspects of the invention. Changeout of the gaming machine, repair or replacement of the exterior of the cabinet, and other benefits are apparent over the prior art, as well as the associated costs savings that can result from the aforementioned standardization of various components. Costs and methods for inventorying and producing the necessary components for the cabinets 10 should be substantially lower than prior art approaches, due to the advantages of mass production, standardization, etc.

The apparatus and methods of my invention have been described with some particularity, but the specific designs, constructions and steps disclosed are not to be taken as delimiting of the invention. Obvious modifications will make themselves apparent to those of ordinary skill in the art, all of which will not depart from the essence of the invention and all such changes and modifications are intended to be encompassed within the appended claims.

I claim:

1. An article of furniture for the installation and support of gaming machines comprising: a box in which a side is completely or partially open and has means for attaching a removable interface plate to the side that is partially open, said interface plate being configured to attach to one or more selected models of gaming machines.

2. The article of furniture of claim 1, further including a plurality of decorative panels whereby each panel corresponds to an exposed surface of said box; means for attaching said decorative panels to the sides of said box.

3. An article of furniture for the installation and support of gaming machines comprising a box in which a side is completely or partially open and has means for attaching a removable interface plate to the side that is partially open whereby said interface plate is configured so that a specific model of gaming machine may be installed thereupon.

4. The article of furniture in claim 1 further including a plurality of interface plates wherein each of said interface plates provide attachment means for a selected one or more gaming machines and each have uniform attachment means for connecting to said side that is partially open.

5. The article of claim 3, in which said interface plates contain one or more openings therethrough that correspond to specific configurations of one or more selected gaming machines, said one or more openings positioned to permit overflow coins and electrical wiring to pass from the machine through the side that is partially open.

6. The article of furniture in claim 1 wherein said decorative panels are made of vinyl/metal laminate whereby said decorative panels resist incidental damage from cigarettes and similar damaging agents.

7. The article of furniture in claim 1 wherein said box has means for accessing the interior of said box.

8. The article of furniture in claim 1 wherein said decorative panels have means for attachment to said box whereby no exposed fasteners are visible.

9. A method of installing a plurality of support structures for gaming machines, including the steps of: providing a plurality of support structures, each having an opening therethrough; arranging said support structures in a gaming room; providing a plurality of interface elements adapted to be positioned adjacent said openings, said interface elements having one or more attachment structures thereon for attachment to a selected gaming machine, and means for removably attaching said interface element to said support structure so that said element is adjacent said opening; attaching said interface plates adjacent respective of said openings; and attaching decorative panels to said support structures.

10. A system of providing a plurality of gaming machines in a casino environment, including: providing a plurality of uniform support structures for said gaming machines; and providing a plurality of replaceable decorative panels attachable to said uniform support structures.

11. The system of claim 10, further including providing one or more upwardly facing openings in said support structures; providing a plurality of interface elements adapted to be positioned adjacent said openings, each of said interface elements having one or more attachment structures thereon for attachment to a selected gaming machine, and means for removably attaching said interface elements to any of said support structures so that each selected of said elements is adjacent a corresponding one of said openings.

12. A method of removing and replacing gaming machines in a casino environment, including the steps of: providing a plurality of uniform support structures for said gaming machines, each support structure having one or more openings positioned toward a corresponding one of said machines; providing a plurality of interface elements adapted to be positioned adjacent said openings, said interface elements having one or more attachment structures thereon for attachment to a selected gaming machine, and means for removably attaching said interface element to any of said support structure so that said element is adjacent said corresponding opening; removing the gaming machine from said support structure; if the new machine includes features not adaptable to the existing interface plate, removing the interface plate and attaching an interface plate adapted to the new gaming machine, and attaching said new gaming machine to said new interface plate.

13. A support structure for a gaming machine, including a supporting surface having an opening therethrough, an interface element adapted to be positioned adjacent said opening, said interface element having one or more attachment structures thereon for attachment to a selected gaming machine, and means for removably attaching said interface element to said support structure so that said element is adjacent said opening.

14. The support structure of claim 13, including a plurality of replaceable decorative panels attachable to said support structure.
